(19) United States
(12) Patent Application Publication
(10) Pub. No.: US 2009/0053541 A1
(43) Pub. Date: Feb. 26, 2009

(54) COMPOSITIONS FOR CARTON SEALING

(76) Inventors: G. Frederick Hutter, Charleston, SC (US); Jean C. St. Arnauld, Charleston, SC (US)

Correspondence Address: MEADWESTVACO CORPORATION;ATTN: IP LEGAL DEPARTMENT, 1021 MAIN CAMPUS DRIVE, RALEIGH, NC, 27606, US

(21) Appl. No.: 11/842,354

(22) Filed: Aug. 21, 2007

(51) Int. Cl. B32B 27/36; B65B 51/02; C09J 4/00

(52) U.S. Cl. 428/480; 523/176; 53/476

(57) ABSTRACT

The disclosed invention is to provide an adhesive composition for application to a paperboard carton via water-based flexographic printing and subsequently be activated (i.e., melted) by RF radiation during a carton sealing operation. The activated composition provides water- and heat-resistant bonding.

### FIELD OF THE INVENTION

This invention relates to a method for sealing cartons that entails printing an adhesive composition on one or more flaps of an unfolded carton using a water-based flexographic or gravure process, followed by activating the adhesive with radio frequency radiation and folding the flaps to form the sealed carton. Specifically, it discloses adhesive compositions useful in this process that can be printed flexographically, dried to a water-resistant and heat-resistant state, and subsequently activated by radio frequency radiation.

### BACKGROUND OF THE INVENTION

Hot melt adhesives are widely used to seal paperboard cartons such as those used to store and transport beer cans, soda bottles and similar items. The hot melt adhesives have a very rapid set time which makes them highly suited to the high-speed assembly machinery that is used for filling and closing the cartons.

However, hot melt application equipment is subject to frequent plugging. This plugging is the primary cause of stoppages and down time on carton filling machinery.

It would therefore be desirable if an adhesive could be pre-applied to the flaps of cartons that are to be sealed and then be activated in some manner at the point where the sealing is to take place. The ideal way to apply such an adhesive would be during the process wherein the cartons are printed. This would be far more efficient that applying it in a separate manufacturing step. Since most paperboard cartons are printed by flexography using water-based inks, a reactivatable adhesive that could be applied by this process would be most desirable.

A number of possible ways of producing reactivatable adhesives have been considered in the past but have been rejected for various reasons. For example, water-remoistenable adhesives set too slowly because of the high amount of energy needed to drive off the water. Furthermore, such adhesives are objectionable for many carton applications that require the final sealing bond to be water-resistant. A typical example of this would be cartons for beverages that are refrigerated, where the cartons are subject to contact with moisture during the refrigerator's defrosting cycle. Adhesives containing microencapsulated activators have been tried, but their activation speed is limited by the mass transport rate of the encapsulated component.

One way of rapidly reactivating an adhesive would be to melt it by heating with radio frequency (hereinafter RF) radiation. U.S. Pat. No. 6,348,679 and U.S. Pat. No. 6,600,142 disclose methods of sealing various substrates by reactivating a pre-applied adhesive with RF radiation. The adhesive coatings taught in these patents comprise two components: A polar polymer, such as a sulfonated polyester, and a highly polar, non-aqueous carrier. While such adhesives are readily activated by RF radiation due to the aromatic ester bonds in the sulfonated polyesters, they are completely unsuitable for application by flexographic printing due to the presence of the polar carrier. The polar solvents described as carriers U.S. Pat. No. 6,348,679 and U.S. Pat. No. 6,600,142 have very high boiling points whereas flexographic inks require relatively low boiling point solvents in order to dry properly on the press. Typically, in water-based flexography the solvent consists of water and small amounts alcohols containing 1-4 carbon atoms. The polar “carriers” described in the prior art would not evaporate under typical flexographic printing conditions, and their presence in the printed film would render it tacky and cause blocking problems when the printed cartons are subsequently handled.

As noted above, an important consideration for an adhesive used on beverage cartons is that the final bond be waterproof. This is not a problem with conventional hot melt adhesives, which are usually water-resistant. However, the compositions disclosed in U.S. Pat. No. 6,348,679 and U.S. Pat. No. 6,600,142, being mixtures of highly polar polymers and highly polar solvents, are very water sensitive and will not stand up to the “dunk test” usually applied to such cartons. As the name implies, this test consists of immersing a carton full of beverage can in water for a set period of time and observing whether any of the adhesive bonds fail. This lack of water resistance is particularly true of the preferred sulfonated polyesters described in U.S. Pat. No. 6,348,679 and U.S. Pat. No. 6,600,142. Theses commercially available sulfonated polyesters are sold with the water-solubilizing sulfonate groups in the form of permanent sodium salts, which renders them permanently water-dispersible.

A further requirement for adhesives for cartons is resistance to bond failure at elevated temperatures since cartons of beverages are often stored in hot warehouses or transported in hot trucks during the summer season, particularly in warm climates. The compositions disclosed in U.S. Pat. No. 6,348,679 and U.S. Pat. No. 6,600,142 would have poor resistance to high temperature due to the plasticizing effect of the high-boiling organic solvents that they contain.

### SUMMARY OF THE INVENTION

The object of the current invention is to provide an adhesive composition that can be applied to a paperboard carton via water-based flexographic printing, that can subsequently be activated (i.e., melted) by RF radiation during a carton sealing operation, and that provides water-resistant and heat-resistant bonding.

### DESCRIPTION OF THE PREFERRED EMBODIMENT

The object of the present invention is met by providing an aqueous composition comprising two resinous components: (a) a non-sulfonated, water-dispersible aromatic polyester, and (b) a water-dispersible polyurethane.

The aromatic polyester provides the “antenna” to absorb the energy from the RF radiation. It is well known that aromatic esters, such as isophthalates and terephthalates will absorb in the RF range. This range includes 13.56 MHz and its harmonics (e.g., 27.12 MHz, 40.68 MHz, etc.) which have been licensed by the FCC for industrial use. Commercial irradiating units have been produced for various applications with operating frequencies as high as 120 MHz. For example, RF at these frequencies can be used to melt polyethylene terephthalate plastics for processing.

Any polyester whose acid component is substantially aromatic, which contains no sulfonic acid groups or their salts, and which can be readily dispersed in water is suitable for use in the present invention. The preferred aromatic acids are isophthalic acid and terephthalic acid. The glycol component of the polyester may be chosen from any organic compounds that contain at least two hydroxyl groups. The major consideration in the choice will be the desired hardness of the resin. The hardness of each of the three components and all of them taken together is important in that the total composition should be hard enough as not to cause blocking of the printed paperboard cartons when they are subsequently handled or transported. It is well known in the art that certain glycols, such as cyclohexanedimethanol or neopentyl glycol, will produce relatively hard polyesters, whereas other glycols, such as diethylene glycol will produce soft ones.

Water dispersable polyesters that are made from recycled polyester plastics, such as soda bottles or carpet fiber are particularly favored for use in the present invention for environmental reasons. Typical polyesters of this type are supplied by EvCo Products under the trade name EVCOAT and are described in U.S. Pat. No. 5,858,551 and U.S. Pat. No. 5,958,601, which are incorporated herein by reference. Polyesters of this type can be readily dispersed in water in the presence of a fugitive base such as ammonia, alkyl amines, or alkanolamines. Suitable amines include, but are not limited to methylamine, dimethyleamine, trimethylamine, ethylamine, diethylamine, triethylamine, morpholine, and the like, and mixtures thereof. Suitable alkanolamines include, but are not limited to ethanolamine, diethanolamine, triethanolamine, isopropanolamine, diisopropanolamine, triisopropanolamine, dimethylethanolamine, triethanolamine, methyldiethanolamine, and the like, and mixtures thereof.

The urethane component enhances the adhesion of the composition, particularly at elevated temperatures. Most urethanes also have some susceptibility to RF radiation, which can supplement the absorption of such radiation by the polyester.

Any water-dispersible polyurethane may be used in the current invention, provided that it is compatible with the water-dispersible polyester. Water-dispersible polyurethanes are described in detail in Progress in Organic Coatings, 9, 281-340 (1981), which is incorporated herein by reference. The polyurethanes dispersions described in part four of this reference are particularly suitable for use in the present invention.

Typical water-based polyurethane dispersions that are suitable for use in the present invention are sold commercially under the trade names such as Sancure (Noveon Corp.), Witcobond (Chemtura Corp.), Cydrothane (Cytec Industries), and Urotuf (Reichhold Corp.).

Optionally, an acrylic or styrenic latex may be added to the composition of the present invention to enhance bond strength and further contribute to water-resistance of the final bond. It also will increase the drying rate of the composition during flexographic printing. Such latices are manufactured from styrene, substituted styrenes, acrylic esters, and methacrylic esters by well-known emulsion polymerization methods. Any of the latices of this type that are commonly used in water-based flexographic inks are suitable for use in the present invention. Typical products of this type are commercially available under trade names such as JONCRYL (S.C.Johnson) and RHOPLEX (Rohm&Haas). These acrylic polymers are available with a wide range of glass transition temperature (Tg), generally from −40 to +100° C. For the purposes of the present invention, it is useful to select a resin that is sufficiently hard (high Tg) so that the reactivatable coating will not block when unsealed cartons are stacked during processing or shipment. At the same time, the Tg should not be too high or it will raise the melting point of the overall coating and thereby increase the reactivation time. The selection of a latex with an appropriate Tg will also depend on the softening points of the other components of the coating, as discussed above, and the relative ratios of the ingredients. One skilled in the art of formulating flexographic printing inks, where blocking is also an issue, will already be familiar with the properties of these acrylic and styrenic latices, and should be able to select an appropriate latex for a given application.

The components of the present invention, the aromatic polyester, the urethane, and (optionally) the acrylic or styrenic latex can be blended together to make the water-based, flexographically printable by first dissolving or dispersing the polyester in aqueous base and then mixing the resulting solution with the urethane dispersion and (optionally) the latex. The components may be mixed in any order. Simple stirring is all that is required for complete mixing. Alternatively, sufficient water and base to dissolve the polyester can first be added to a mixture of the urethane dispersion and (optionally) the latex, and the polyester can then be dissolved in the mixture. Other orders of addition may be envisioned; all of them will result in a suitable printable adhesive.

To function well on a flexographic printing press, the final blended coating should have a viscosity of about 8 to about 40 seconds as measured with a No. 2 Shell cup. A viscosity of about 18 to about 30 seconds is most preferable. The viscosity can be adjusted by the addition of water or small amounts of thickeners, such as polyvinyl alcohol or associative thickeners, whose use will be familiar to one skilled in the art of formulating flexographic inks.

For stability during the printing process, the pH of the printable adhesive composition should be maintained in a range of about 7.5 to about 10.0. The pH can be adjusted using any of the fugitive bases described above.

### EXAMPLES

The invention may be illustrated by the following examples, which are not to be construed as limiting the invention in any way.

### Preparation of a Flexographically Printable RF-Activatable Adhesive:

Sixty parts by weight of EVCOAT P56S-30 (a 30% solids aqueous dispersion of a non-sulfonated aromatic polyester resin supplied by EvCo Products), 25 parts by weight of SANCURE 1601 (an aqueous polyurethane dispersion from Noveon), 10 parts by weight of deionized water, and 5 parts by weight of isopropyl alcohol were blended with vigorous stirring to produce a printable aqueous adhesive with a solids content of 33%, a pH of 8.0, and a viscosity of 25 seconds as measured with a No. 2 Zahn cup.

### Printing the RF-Activatable Adhesive

The composition prepared above was successfully printed on 18 point CarrierKote board (a grade of paperboard supplied by MeadWestvaco that is used to manufacture beverage cartons) using a Comco Captain pilot scale flexographic printing press. No problems were seen in the transfer of the material into the cells of the anilox roll, transfer of the material from the anilox roll to the plate, or transfer of the material from the plate to the board substrate.

### Testing RF Response

Board coated with the composition prepared above was tested for RF activation by placing a strip of uncoated board against a strip of uncoated board in a jig made from UHMW polyethylene (which is transparent to RF radiation). The assembly was the subjected to RF radiation of 100 MHz frequency for two seconds in a THERMALL Model 950 machine manufactured by Radio Frequency Company of Millis, Mass. Upon disassembly of the jig, it was found that there was a fiber-tearing bond between the two pieces of board.

The heat resistance of the RF-sealed samples was tested using a procedure developed by Applied Paper Testing (APT) in Atlanta Ga. This test is basically a variation on a class of tests called T-peel tests that are widely used to evaluate bonds between flexible substrates. ASTM D-1876, for example is a widely used T-peel test. In the APT test, a 1″×3″ sample of board with an RF-sealed adhesive area of ½″×1″ is hung in a 60° C. oven in the shape of a “T”. The bonded area is the base of the “T”, and the sample is hung by one side of the top of the “T”, while a one pound weight is hung form the other side of the top of the “T” (note that the “T” is now at right angles to the bottom of the oven. The printed, sealed samples of this invention when tested in this manner hung for 24 hours without any sign of bond failure.

1. An aqueous, radio frequency activatable composition comprising (a) a water-dispersible, non-sulfonated aromatic polyester and (b) an aqueous polyurethane dispersion.

2. The composition of claim 1 comprising from about 50 to about 95% by weight on a dry basis of component (a) and from about 5 to about 50% by weight on a dry basis of component (b).

3. The composition of claim 1 where the water-dispersible polyester is made from chemical processing of recycled polyester bottles, fibers, or other molded or extruded polyester products.

4. The composition of claim 1 wherein the composition has a viscosity of from about 5 seconds to about eight to about 40 seconds as measured by a No. 2 Zahn cup.

5. The composition of claim 1 wherein the composition has a pH of about 7.5 to about 10.0.

6. An article printed with the composition of claim 1 by a flexographic printing process.

7. The composition of claim 1 further comprising (c) a latex material selected from the group consisting of acrylic and styrene lattices and combinations thereof.

8. An article printed with the composition of claim 1 by gravure printing process.

9. A method for sealing cartons comprising printing an adhesive composition (a) a water-dispersible, non-sulfonated aromatic polyester and (b) an aqueous polyurethane dispersion.

10. The method of claim 10 wherein the composition comprises from about 50 to about 95% by weight on a dry basis of component (a) and from about 5 to about 50% by weight on a dry basis of component (b).

11. The method of claim 10 where the water-dispersible polyester is made from chemical processing of recycled polyester bottles, fibers, or other molded or extruded polyester products.

12. The method of claim 10 wherein the composition has a viscosity of from about 5 seconds to about eight to about 40 seconds as measured by a No. 2 Zahn cup.

13. The method of claim 10 wherein the composition has a pH of about 7.5 to about 10.0.
